(19) United States
(12) Patent Application Publication
(10) Pub. No.: US 2024/0061887 A1
(43) Pub. Date: Feb. 22, 2024

(54) INFORMATION SEARCH METHOD AND APPARATUS, COMPUTER DEVICE AND STORAGE MEDIUM

(71) Applicant: Beijing Bytendance Network Technology Co., Ltd., Beijing (CN)

(72) Inventors: Jinghua LI, Beijing (CN); Guibo Pan, Beijing (CN); Yiyong Li, Beijing (CN); Dongling Gao, Beijing (CN); Qi Deng, Beijing (CN)

(21) Appl. No.: 18/500,887

(22) Filed: Nov. 2, 2023

Related U.S. Application Data
(63) Continuation of application No. PCT/CN22/93922, filed on May 19, 2022.

(30) Foreign Application Priority Data
Jul. 2, 2021 (CN) 202110755050.0

(51) Int. Cl. G06F 16/903; G06F 16/9032; G06F 16/9038

(52) U.S. Cl. CPC G06F 16/90344; G06F 16/90332; G06F 16/9038

(57) ABSTRACT

The present disclosure provides an information search method and apparatus, a computer device and a storage medium. The method includes: receiving search information; acquiring multiple pieces of topic content corresponding to a keyword in the search information and first book information included in each piece of topic content; and displaying a topic card on a search result page, wherein the topic card includes the multiple pieces of topic content and the first book information. In this way, book information related to the search information can be found by searching for the topic content without limiting the search information input by a user. Therefore, this search method can adapt to various search information input by the user, and the search efficiency of the user is thus improved.

### CROSS-REFERENCE TO RELATED APPLICATION

This application is a Continuation Application of International Patent Application No. PCT/CN2022/093922, filed on May 19, 2022, which claims priority to Chinese Application No. 202110755050.0, filed on Jul. 2, 2021, the disclosures of which are incorporated herein by reference in their entities.

### FIELD

The present disclosure relates to the technical field of computers, and in particular, to an information search method and apparatus, a computer device and a storage medium

### BACKGROUND

In related art, when book search is performed, a user generally inputs search information in a search box, and then initiates a search request. After receiving the search request, a server may search for a book corresponding to the search information, and then sends the searched book to a user terminal.

In this search method, the search information input by the user is generally a book name or a book type. When the user cannot determine the book name or the book type that he/she needs to search, for example, the search information input by the user is “a novel in which the male protagonist is a doctor,” the search information is neither a book name nor a book type. Therefore, book search cannot be performed based on the search information in the related art, and thus the search requirements of the user cannot be satisfied.

### SUMMARY

Embodiments of the present disclosure at least provide an information search method and apparatus, a computer device and a storage medium.

In a first aspect, embodiments of the present disclosure provide an information search method, including:
receiving search information;
acquiring multiple pieces of topic content corresponding to a keyword in the search information and first book information included in each piece of topic content; and
displaying a topic card on a search result page, wherein the topic card includes the multiple pieces of topic content and the first book information.

In a second aspect, embodiments of the present disclosure further provide an information search apparatus, including:
a receiving module, configured to receive search information;
an acquisition module, configured to acquire multiple pieces of topic content corresponding to a keyword in the search information and first book information included in each piece of topic content; and
a display module, configured to display a topic card on a search result page, wherein the topic card includes the multiple pieces of topic content and the first book information.

In a third aspect, embodiments of the present disclosure further provide a computer device, including: a processor, a memory and a bus, wherein the memory stores a machine-readable instruction executable by the processor, when the computer device operates, the processor communicates with the memory through the bus, and the machine-readable instruction, when executed by the processor, executes the steps in the first aspect or any possible implementation in the first aspect.

In a fourth aspect, embodiments of the present disclosure further provide a computer-readable storage medium, wherein a computer program is stored on the computer-readable storage medium, and the computer program, when run by a processor, executes the steps in the first aspect or any possible implementation in the first aspect.

In the information search method provided according to embodiments of the present disclosure, after the search information is received, multiple pieces of topic content corresponding to the keyword in the search information and first book information included in each piece of topic content may be acquired, and then the topic content and the first book information may be displayed on the search result page. In this way, book information related to the search information can be found by searching for the topic content without limiting the search information input by the user. Therefore, this search method can adapt to various search information input by the user, and the search efficiency of the user is thus improved.

In order to make the above objectives, features and advantages of the present disclosure more comprehensible, preferred embodiments are described in detail below with reference to the drawings.

### BRIEF DESCRIPTION OF THE DRAWINGS

To illustrate technical solutions of the embodiments of the present disclosure more clearly, a brief introduction on the drawings which are needed in the description of the embodiments is given below. The drawings herein are incorporated in and constitute a part of the present specification, and these drawings illustrate embodiments consistent with the present disclosure, and serve to explain the technical solutions of the present disclosure along with the specification. It should be understood that the following drawings only illustrate certain embodiments of the present disclosure, and therefore should not be considered as limiting the scope of the present disclosure. Those ordinary skilled in the art may also obtain other related drawings according to these drawings without any inventive effort.

FIG. 1 illustrates a flowchart of an information search method provided according to an embodiment of the present disclosure;

FIG. 2 illustrates a flowchart of a specific method for determining, based on comment information of any piece of target topic content, first book information included in the target topic content in the information search method provided according to an embodiment of the present disclosure;

FIG. 3a illustrates a schematic diagram of displaying a topic card provided according to an embodiment of the present disclosure;

FIG. 3b illustrates a schematic diagram of displaying another topic card provided according to an embodiment of the present disclosure;

FIG. 4 illustrates a schematic diagram of associated search information displayed on a search result page provided according to an embodiment of the present disclosure;

FIG. 5 illustrates a schematic diagram of a book recommendation card displayed on a search result page provided according to an embodiment of the present disclosure;

FIG. 6 illustrates a schematic diagram of another search result page provided according to an embodiment of the present disclosure;

FIG. 7 illustrates a schematic architectural diagram of an information search apparatus provided v an embodiment of the present disclosure; and

FIG. 8 illustrates a schematic structural diagram of a computer device provided according to an embodiment of the present disclosure.

### DETAILED DESCRIPTION OF EMBODIMENTS

In order to make the objectives, technical solutions and advantages of the embodiments of the present disclosure clearer, a clear and complete description of the technical solutions in the embodiments of the present disclosure will be given below, in combination with the drawings in the embodiments of the present disclosure. Apparently, the embodiments described below are merely a part, but not all, of the embodiments of the present disclosure. In general, components of the embodiments of the present disclosure, which are described and illustrated herein, may be arranged and designed in a variety of different configurations. Therefore, the following detailed description of the embodiments of the present disclosure provided in the drawings is not intended to limit the claimed scope of the present disclosure, but merely represents a selected embodiment of the present disclosure. All of other embodiments, obtained by those ordinary skilled in the art based on the embodiments of the present disclosure without any creative effort, fall into the protection scope of the present disclosure.

As studied, in the related art, when book search is performed, a user generally inputs search information in a search box, and then initiates a search request. After receiving the search request, a server may search for a book corresponding to the search information, and then sends the searched book to a user terminal. In this search method, the search information input by the user is generally a book name or a book type, and when the user cannot determine the book name or the book type that he/she needs to search, for example, the search information input by the user is “a novel in which the male protagonist is a doctor,” the search information is neither a book name nor a book type. Therefore, the book search cannot be performed based on the search information in the related art, and thus the search requirement of the user cannot be satisfied.

Based on the above studies, the present disclosure provides an information search method and apparatus, a computer device and a storage medium. After search information is received, multiple pieces of topic content corresponding to a keyword in the search information as well as first book information included in each piece of topic content may be acquired, and then the topic content and the first book information may be displayed on a search result page. In this way, book information related to the search information can be found by searching for the topic content without limiting the search information input by the user. Therefore, this search method can adapt to various search information input by the user, and the search efficiency of the user is thus improved. The defects of the above solutions are results obtained by the inventors after practices and careful researches, therefore, the discovery processes of the above problems and the solutions proposed in the present disclosure for the above problems should all be contributions of the inventors to the present disclosure in the process of the present disclosure.

It should be noted that, similar reference signs and letters represent similar items in the following figures, therefore, once a certain item is defined in one figure, there is no need to further define and interpret the item in the subsequent figures.

In order to facilitate understanding of the present embodiments, firstly, an information search method disclosed according to an embodiment of the present disclosure is described in detail, the executive entity of the information search method provided according to an embodiment of the present disclosure is generally a terminal device, and the terminal device may be, for example, a smart phone, a tablet computer, a smart television, etc.

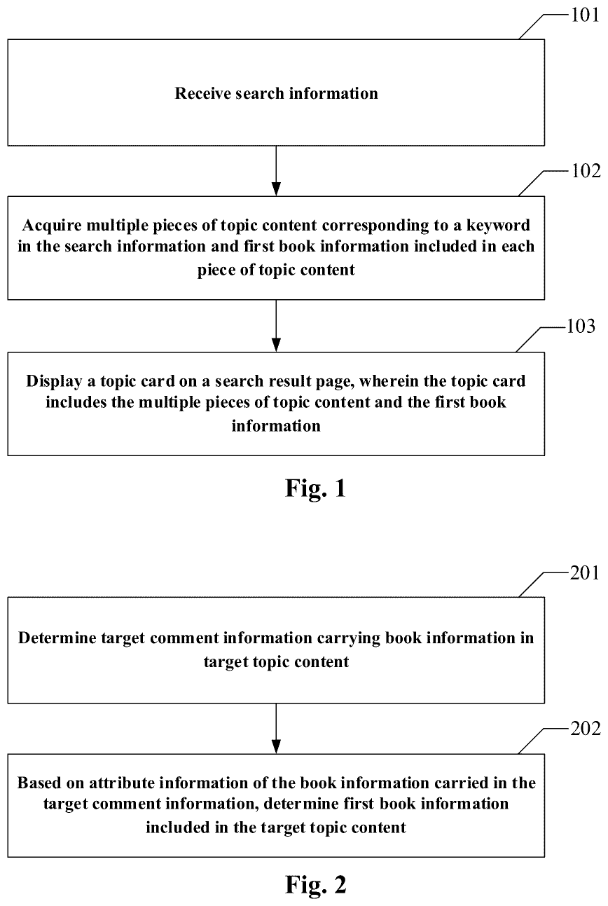

Referring to FIG. 1, which is a flowchart of an information search method provided according to an embodiment of the present disclosure, the method includes a steps 101 to 103, in which:

Step 101: receiving search information.

Step 102: acquiring multiple pieces of topic content corresponding to a keyword in the search information and first book information included in each piece of topic content.

Step 103: displaying a topic card on a search result page, wherein the topic card includes the multiple pieces of topic content and the first book information.

The above steps are described below in detail.

For step 101:

In a possible implementation, the search information may be information input by the user in a search box of a target application program. The target application program may be an application program used for performing book search and reading.

Exemplarily, the search information may be a book name, a book type (e.g., romantic novels, time-travel novels, horror novels, e-sports novels, and the like), and may also be any search word related to a book (e.g., may be a general network word), for example, may be happy ending (HE) novels, refreshing novels and complex novels, etc.

In a possible implementation, if the executive entity of the method provided according to the present disclosure is a user terminal, after the user triggers a search button, a search request may be initiated to a server based on the search information input by the user. And then the server may search for multiple pieces of topic content corresponding to the search information and first book information included in each piece of topic content. Alternatively, the user terminal may parse the search information to determine a keyword in the search information, and then send the keyword to the server, so that the server searches for multiple pieces of topic content corresponding to the keyword and first book information included in each piece of topic content.

When parsing the search information to determine the keyword in the search information, exemplarily, the user terminal may perform word segmentation processing on the search information (e.g., perform the word segmentation processing by means of an N-gram model), so as to determine the keyword in the search information.

For step 102:

Herein, the multiple pieces of topic content corresponding to the keyword in the search information may refer to topic content including the keyword in the search information, and/or may refer to topic content including an associated keyword corresponding to the keyword in the search information.

The associated word corresponding to the keyword may be, for example, a synonym, a homoionym and the like corresponding to the keyword.

In a possible implementation, the step of determining the multiple pieces of topic content corresponding to the keyword in the search information may be executed by the server. After receiving the search request which is sent by the user terminal and carries the search information, the server may firstly determine the keyword in the search information, and then search for, from a topic information base, first topic content including the keyword, and use the searched first topic content as the multiple pieces of topic content corresponding to the keyword in the search information. And then, the user terminal may acquire the multiple pieces of searched topic content from the server.

Alternatively, after determining the keyword in the search information, the associated keyword corresponding to the keyword may be determined. Then, second topic content including the associated keyword is searched from the topic information base. The searched first topic content and the second topic content are used together as the topic content corresponding to the keyword in the search information.

The topic information base stores topic content sent by multiple users.

Alternatively, the release time of each piece of topic content is further stored in the topic information base. When the topic content (including the first topic content and the second topic content) is searched from the topic information base, the topic content may be searched from multiple pieces of topic content of which the release times meet a preset condition. For example, the topic content may be searched from topic content of which the release time is less than a predefined duration from the current time instance.

In a possible implementation, the first book information included in each piece of topic content is determined according to comment information in each piece of topic content, and the first book information includes a book cover and/or a book name.

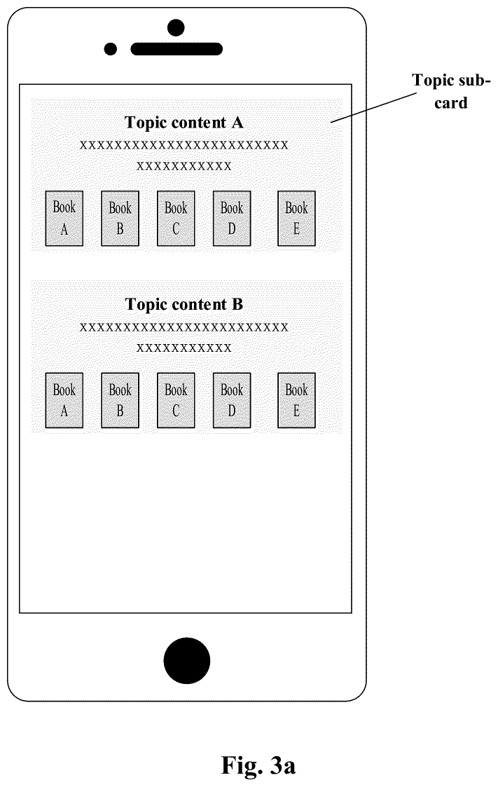

Exemplarily, when determining the first book information included in the target topic content based on the comment information in any piece of target topic content, the method as shown in FIG. 2 may be used. FIG. 2 may include the following steps:

Step 201: determining target comment information that carries book information in the target topic content.

For any piece of comment information, when determining whether the comment information carries the book information, in a possible implementation, the keyword included in the comment information may be determined at first, and then the keyword is matched with each piece of book information stored in a book information base. The successfully matched book information is used as the book information carried in the comment information, and the comment information is determined to be the target comment information.

When determining the keyword included in the comment information, there may be several cases as follows:

Case 1: the comment information is comment information carrying an image.

In this case, character information included in the image may be recognized, and then the keyword is determined based on the character information.

Exemplarily, character recognition may be performed on the image carried in the comment information by means of an optical character recognition (OCR) technology, and then a character recognition result is matched with each piece of book information (referred to herein as the book name) stored in the book information base, so as to determine whether the image carries the book information. If the matching is successful, it is determined that the comment information carries the book information.

The foregoing manner of character recognition is merely exemplary, and the present disclosure does not exclude other manners capable of performing character recognition.

Case 2: the comment information is comment information carrying text information.

In this case, word segmentation processing is performed on the text information, so as to determine the keyword included in the comment information. Exemplarily, the word segmentation processing may be performed on the text information by means of the N-gram model.

Alternatively, in another possible implementation, if the comment information is comment information carrying text information, the text information may be directly matched with multiple pieces of book information (referred to herein as book names) stored in the book information base. The successfully matched book information is used as book information carried in the text information.

Case 3: the comment information is comment information carrying audio information.

In this case, character recognition may be performed on the audio information at first, so as to determine text information corresponding to the audio information. And then, book information included in the audio information is determined based on the method as described in Case 2.

Step 202: determining the first book information included in the target topic content based on attribute information of the book information carried in the target comment information.

The attribute information of the book information may include any one of the following:
the number of target comment information carrying the book information, the number of target comment information carrying the book information, the number of times for displaying a book corresponding to the book information, the number of searches, and total reading duration, etc.

When determining the first book information included in the target topic content based on the attribute information of the book information carried in the target comment information, book information of which the corresponding attribute information meets a first preset attribute condition may be used as the first book information.

Exemplarily, when the attribute information of the book information includes the number of target comment information carrying the book information, book information of which the corresponding number exceeds a preset number may be used as the first book information; or, all book information may be sorted according to corresponding numbers from large to small, and then first N pieces of book information are used as the first book information.

By means of this method, when there is no book matching the keyword in the search information, the search for the book information may be realized by searching for the topic content corresponding to the keyword in the search information. In this way, book information related to the search information can be found by searching for the topic content without limiting the search information input by the user. Therefore, this search method can adapt to various search information input by the user, and the search efficiency of the user is thus improved.

In a possible implementation, the absence of the book matching the keyword in the search information includes:
the search information includes a book name, but there is no book corresponding to the book name in the database; or,
it is detected that the search information does not include a book name.

Specifically, there may be two databases, wherein the first database is used for storing book names, and the second database is used for storing books. Book names of the books stored in the second database are necessarily present in the first database, while books corresponding to the book names in the first database are not necessarily present in the second database. For example, if the keyword in the search information includes “The Romance of the Three Kingdoms,” by means of matching with the book names in the first database, it is determined that “The Romance of the Three Kingdoms” is a book name, but there is no book of “The Romance of the Three Kingdoms” in the second database, therefore it can be determined that there is no book matching “The Romance of the Three Kingdoms”.

In a possible implementation, if it is detected that there is a book matching the keyword in the search information, book information corresponding to the book may be directly displayed on the search result page; or, the book information corresponding to the book may be displayed at a first place of the search result page, and then a topic card is displayed below the displayed book information.

In a possible implementation, after acquiring the first book information included in each piece of topic content, target book information matching the search information may also be determined from the first book information based on the attribute information of the first book information included in each piece of topic content, and the topic card including the above-mentioned target book information is displayed on the search result page.

Here, the target book information may include the book information of the book matching the keyword in the search information.

Exemplarily, if the search information is “The Romance of the Three Kingdoms,” and there is a book matching the search information, the cover and/or book name of the book “The Romance of the Three Kingdoms” may be displayed at the first place. And then, the topic content may be searched based on the search information. If the first book information included in the searched topic content is book information of a book A, a book B, a book C and a book D, and the target book information determined based on the attribute information of the first book information is the book information of the book C and the book D, then the book information of the book C and the book D may be displayed on the topic card. In this way, the book information of the book “The Romance of the Three Kingdoms” may be displayed at the first place of the search result page, and then the book information of the book C and the book D is displayed on the topic card.

Exemplarily, the attribute information of the first book information may include at least one of the following:
the number of pieces of topic content including the first book information, the number of times for reading the book corresponding to the first book information, the reading duration corresponding to the first book information, and the number of times for sharing the first book.

When determining the target book information matching the search information from the first book information based on the attribute information of the first book information included in each piece of topic content, the first book information of which the corresponding attribute information meets a second preset attribute condition may be used as the target book information.

Exemplarily, when the attribute information of the first book information includes the number of times for reading the book corresponding to the first book information, the first book information of which the corresponding number of times for reading exceeds a preset number of times may be used as the target book information; or, all first book information may be sorted according to the corresponding number of times for reading from large to small, and then first N pieces of first book information are used as the target book information.

By means of this method, when the number of the first book information is relatively large, the first book information may be further screened, so that the screened target book information can be directly displayed for the user to facilitate a quick finding of the interested book.

For step 103

The topic card may refer to a module that is displayed in a block form on the search result page for displaying the topic content. In a possible implementation, when the topic card is displayed on the search result page, the first book information and multiple topic sub-cards may be displayed on an acquired card. The topic content is displayed on the topic sub-cards, and target content, which matches the keyword in the search information, in the topic content is highlighted.

The target content, which matches the keyword in the search information, in the topic content may refer to a word that is the same as or similar to the keyword in the topic content, and highlighting may be, for example, changing a font color, changing a font size, displaying in bold, adding a background color and the like.

Exemplarily, the first book information and multiple topic sub-cards may be displayed on the acquired card in any of the following display methods:

Method A:

The multiple topic sub-cards are displayed on the topic card, and the first book information, which is included in a piece of topic content displayed on each topic sub-card, is displayed on each respective topic sub-cards.

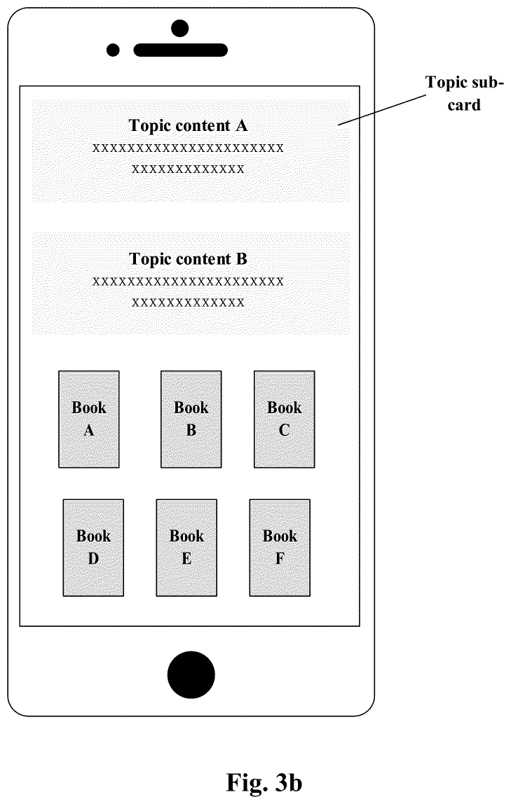

Exemplarily, a schematic diagram of displaying the topic card may be as shown in FIG. 3a.

In this display mode, there is no relationship between the first book information included in each piece of topic content, therefore, there may be cases where different pieces of topic content include the same first book information.

A display sequence for each piece of topic content may be determined according to the relevance with the search information. The higher the relevance with the search information is, the nearer to the front the display position is. Exemplarily, the relevance with the search information may be characterized by a correlation between the topic content and the keyword of the search information.

Exemplarily, a display sequence of the first book information in each piece of topic content may be determined by the number of comment information for recommending the first book information in the topic content, and the greater the number of comment information for recommending the first book information is, the nearer to the front the display sequence of the first book information is.

Method B:

The multiple topic sub-cards are displayed in a first position area of the topic card, and the first book information is displayed in a second position area of the topic card.

Exemplarily, the schematic diagram of displaying the topic card may be shown in FIG. 3b.

In this display mode, the first book information included in each piece of topic content is displayed in an aggregated manner, so that the target book information may be determined according to the attribute information of the first book information by using the method described in step 102, and then the target book information is displayed in the second position area.

In a possible implementation, when search is performed based on the search information, the search information may be relatively fuzzy, so it is impossible to determine whether the search information is a book name or an author name. Therefore, in this case, associated search information matching the search information in at least one dimension may also be determined, wherein the dimension includes an author dimension, a book type dimension and a book name dimension. And then the associated search information is displayed on the search result page, wherein the associated search information is used for prompting a user to perform supplementary search.

Exemplarily, if the search information input by the user is “watermelon,” then associated search information corresponding to the author dimension may be that the author is a “person who loves to eat watermelons,” associated search information corresponding to the book type dimension may be “time-travel novel,” and associated search information corresponding to the book name dimension may be “aa,” “bb,” “cc,” etc.

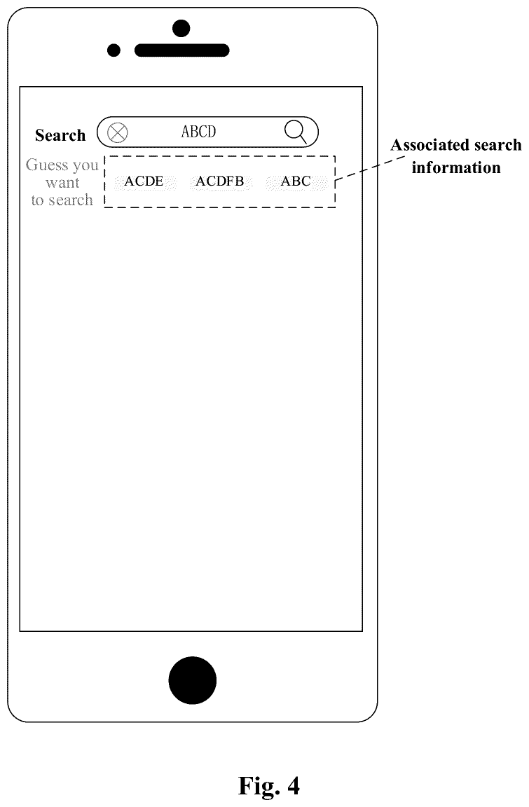

Specifically, when displaying the associated search information, for example, on a page as shown in FIG. 4, the associated search information may be displayed below a search box in the search result page. After any piece of associated search information is triggered, a search request may be directly initiated based on the associated search information, and a search result corresponding to the search request is displayed on the search result page.

By means of displaying the associated search information on the search result page, the user may quickly initiate the search request based on the associated search information when an interested book has not been found based on the current search information, thereby the search efficiency is improved.

In another possible implementation, after acquiring the multiple pieces of topic content corresponding to the keyword in the search information as well as the first book information included in each piece of topic content, word segmentation processing may also be performed on the search information, and when it is detected that the search information includes book feature information, the first book information may be screened based on a preset book feature keyword. In some embodiments, the book feature information is used for describing feature information of a book. And then, when the topic card is displayed on the search result page, the topic card including the screened first book information may be displayed on the search result page.

Here, exemplarily, the book feature information may be information used for describing an update state of a book, for example, the book may be completed, or in update. Alternatively, the book feature information may be information used for describing charge state of a book, for example, the book may be free. Alternatively, the book feature information may be information used for describing the length of a book, for example, the book may be short in length, long in length and the like. Alternatively, the book feature information may be used for describing whether a book has a corresponding audio book, for example, the book may be voiced or the like.

When screening the first book information based on the preset book feature keyword, the first book information of which the corresponding attribute information meets a preset keyword carried in the search information may be screened out and displayed.

In a possible implementation, recommended book information may also be acquired, and a book recommendation card including the recommended book information is displayed on the search result page.

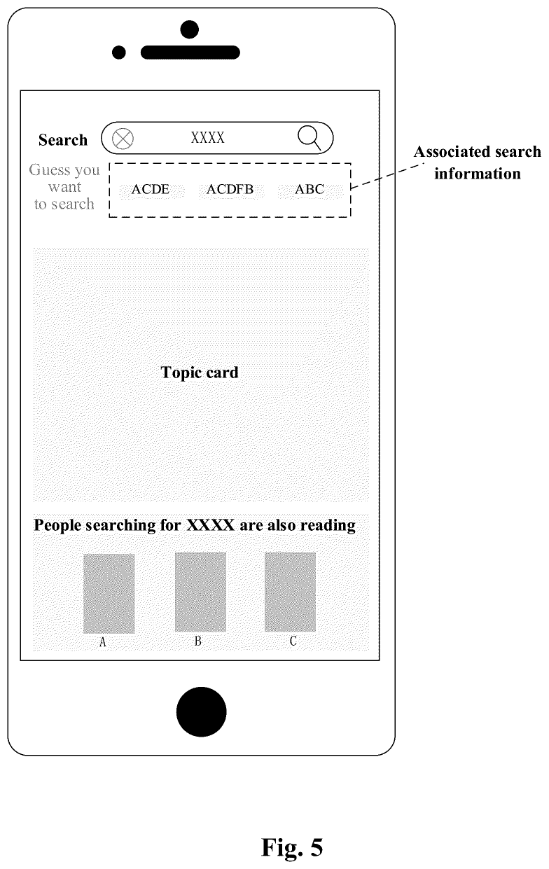

Exemplarily, the book recommendation card displayed on the search result page may be shown in FIG. 5, and the book recommendation card may be displayed below the topic card. A sentence such as “people searching for XXXX are also reading” is displayed on the book recommendation card, wherein “XXXX” may refer to the current search information. A recommended book cover and a book name of the recommended book may be displayed at a lower part of the book recommendation card, and a score of the recommended book may be displayed.

The recommended book information may be acquired in any of the following methods:

Method 1: determining an associated keyword having an association relationship with a keyword in the search information, and acquiring recommended book information corresponding to the associated keyword.

Exemplarily, there may be no matched book for the keyword in the search information, but the associated keyword having the association relationship with the keyword in the search information may have a matched book. And then the book information of the book corresponding to the associated keyword may be directly acquired as the recommended book information.

Method 2: acquiring recommended book information having an association relationship with the first book information.

Here, the recommended book information having the association relationship with the first book information may refer to book information of other books written by a book author corresponding to the first book information, or may refer to book information of other books in the same book type corresponding to the first book information, or may refer to book information of other books with book names that are similar to the book name in the first book information.

Method 3: searching for recommended book information matching the keyword in the search information.

Here, the recommended book information matching the keyword in the search information may refer to recommended book information taking the keyword as the book name, or may refer to book information of a book of which the book name includes the keyword, etc.

In a possible implementation, the search information may further include a book label, and the book label may represent a type of the book (e.g., modern romance, reborn, ancient romance or the like), character features of the book (e.g., son-in-law who lives in the home of his wife's parents, straight-A student, genius or the like), plot type of the book (e.g., entertainment circle, tomb robbing, farming, quadratic element or the like), etc.

Exemplarily, when it is detected that the search information includes a book label, second book information corresponding to the book label is acquired, and the second book information is displayed on the search result page, wherein the book label is used for representing the type of the book.

Acquisition of the second book information corresponding to the book label may refer to acquiring second book information carrying the book label.

Specifically, in the case that the search information includes multiple book labels, the step of acquiring the second book information corresponding to the book label may include:

determining and acquiring second multi-associated book information simultaneously associated with the multiple book labels; and determining and acquiring second single-associated book information associated with any one of the multiple book labels.

After the second book information is acquired, when the search result page is displayed, a first book card and a second book card may be displayed. The multiple book labels and the second multi-associated book information are displayed on the first book card, the second single-associated book information may be displayed on the second book card, and an associated book label in the second single-associated book information is highlighted.

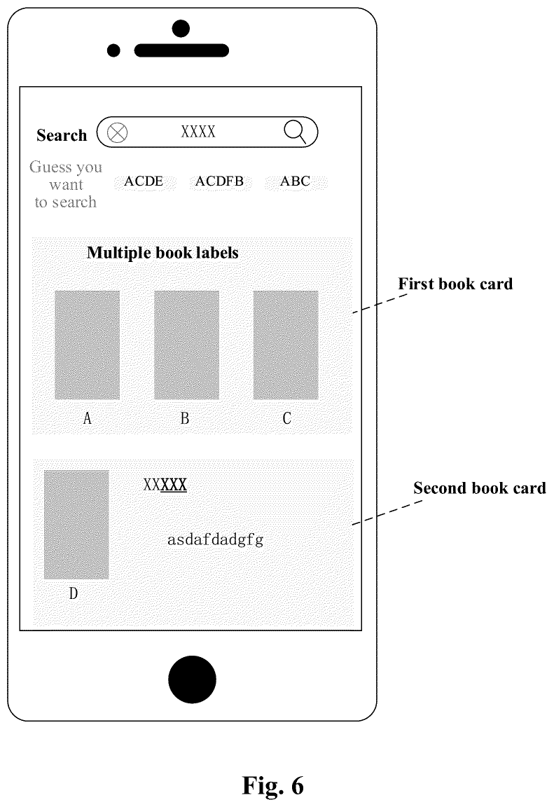

Exemplarily, if the search information includes a book label 1 and a book label 2, the second multi-associated book information simultaneously associated with the book label 1 and the book label 2 includes the book information of a book A, a book B and a book C, and the second single-associated book information associated with the book label 1 includes the book information of a book D, then the book label 1 and the book label 2, as well as the book information of the book A, the book B, and the book C may be displayed on the first book card, and the book information of the book D may be displayed on the second book card. Exemplarily, the first book card and the second book card may be shown in FIG. 6.

It can be understood by those skilled in the art that, in the above methods of specific embodiments, the writing sequence of the steps does not mean that a strict execution sequence constitutes any limitation on the implementation process, and the specific execution sequence of the steps should be determined by the functions and possible internal logic.

Based on the same inventive concept, embodiments of the present disclosure may further provide an information search apparatus corresponding to the information search method, and since the principle of the apparatus for solving problems in embodiments of the present disclosure is similar to the information search method in embodiments of the present disclosure, the implementation of the apparatus may refer to the implementation of the method, and thus details are not described herein again.

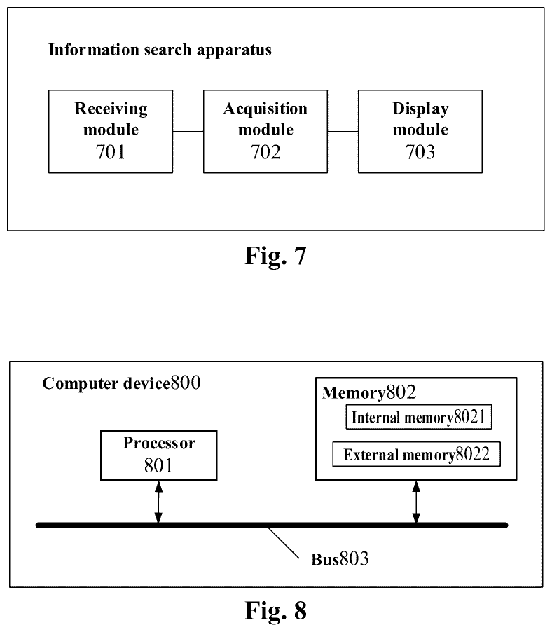

Referring to FIG. 7, which is a schematic architectural diagram of an information search apparatus provided according to an embodiment of the present disclosure. The apparatus may include a receiving module 701, an acquisition module 702, and a display module 703, in which:
the receiving module 701 is configured to receive search information;
the acquisition module 702 is configured to acquire multiple pieces of topic content corresponding to a keyword in the search information and first book information included in each piece of topic content;
the display module 703 is configured to display a topic card on a search result page, wherein the topic card includes the multiple pieces of topic content and the first book information.

In a possible implementation, before acquiring the multiple pieces of topic content corresponding to the keyword in the search information and the first book information included in each piece of topic content, the acquisition module 702 is further configured to:
confirm an absence of a book matching the keyword in the search information;
wherein the absence of the book matching the keyword in the search information includes:
the search information includes a book name, and there is an absence of a book corresponding to the book name in a database; or,
it is detected that the search information does not include a book name.

In a possible implementation, the first book information included in each piece of topic content is determined according to comment information in each respective piece of topic content, and the first book information includes a book cover and/or a book name.

In a possible implementation, after acquiring the first book information included in each piece of topic content, the acquisition module 702 is further configured to:
based on attribute information of the first book information included in each piece of topic content, determine, from the first book information, target book information matching the search information; and
when displaying the topic card on the search result page, the display module 703 is configured to:
display, on the search result page, the topic card including the target book information.

In a possible implementation, when displaying the topic card on the search result page, the display module 703 is configured to:
display the first book information and multiple topic sub-cards on the topic card;
display topic content on the topic sub-cards, and highlight target content in the topic content which matches the keyword in the search information.

In a possible implementation, when displaying the first book information and the multiple topic sub-cards on the topic card, the display module 703 is configured to:
display the multiple topic sub-cards on the topic card, and display, on each topic sub-card, the first book information included in the topic content that is displayed on the topic sub-card; or,
display the multiple topic sub-cards in a first position area of the topic card, and display the first book information in a second position area of the topic card.

In a possible implementation, the display module 703 is further configured to:
determine associated search information matching the search information in at least one dimension, wherein the dimension includes an author dimension, a book type dimension and a book name dimension;
display the associated search information on the search result page, wherein the associated search information is used for prompting a user to perform supplementary search.

In a possible implementation, the acquisition module 702 is further configured to:
perform word segmentation processing on the search information, and when it is detected that the search information includes a preset book feature keyword, screen the first book information based on the preset book feature keyword, wherein the preset book feature keyword is used for describing feature information of a book;
when displaying the topic card on the search result page, the display module 703 is configured to:
display, on the search result page, the topic card including the screened first book information.

In a possible implementation, the acquisition module 702 is further configured to:
acquiring recommended book information;
the display module 703 is further configured to:
display, on the search result page, a book recommendation card including the recommended book information.

In a possible implementation, when acquiring the recommended book information, the acquisition module 702 is configured to:
determine an associated keyword having an association relationship with the keyword in the search information, and acquire recommended book information corresponding to the associated keyword; or,
acquire recommended book information having an association relationship with the first book information; or,
search for recommended book information matching the keyword in the search information.

In a possible implementation, the display module 703 is further configured to:
when it is detected that the search information includes a book label, acquire second book information corresponding to the book label, and display the second book information on the search result page, wherein the book label is used for representing the type of the book.

In a possible implementation, in the case that the search information includes multiple book labels, when acquiring the second book information corresponding to the book label, the display module 703 is configured to:
determine and acquire second multi-associated book information simultaneously associated with the multiple book labels; and determine and acquire second single-associated book information associated with any one of the multiple book labels.

With regard to the description of the processing flows of various modules in the apparatus and the interaction process among the modules, reference may be made to related description in the foregoing method embodiments, and thus details are not described in detail herein.

Based on the same technical concept, embodiments of the present disclosure further provide a computer device. Referring to FIG. 8, which is a schematic structural diagram of a computer device 800 provided according to an embodiment of the present disclosure. The computer device may include a processor 801, a memory 802, and a bus 803. The memory 802 is used for storing an execution instruction, and includes an internal memory 8021 and an external memory 8022. The memory 8021 herein is also referred to as an internal memory for temporarily storing operation data in the processor 801 and data exchanged with the external memory 8022 such as a hard disk. The processor 801 performs data exchange with the external memory 8022 through the memory 8021. When the computer device 800 is running, the processor 801 communicates with the memory 802 through the bus 803, so that the processor 801 executes the following instructions:
receiving search information;
acquiring multiple pieces of topic content corresponding to a keyword in the search information and first book information included in each piece of topic content;
displaying a topic card on a search result page, wherein the topic card includes the multiple pieces of topic content and the first book information.

In a possible implementation, in the instructions executed by the processor 801, before acquiring the multiple pieces of topic content corresponding to the keyword in the search information and the first book information included in each piece of topic content, the method further includes:
confirming an absence of a book matching the keyword in the search information;
wherein the confirmation of the absence of the book matching the keyword in the search information includes:
the search information includes a book name, but there is an absence of a book corresponding to the book name in a database; or,
it is detected that the search information does not include a book name.

In a possible implementation, in the instructions executed by the processor 801, the first book information included in each piece of topic content is determined according to comment information in each respective piece of topic content, and the first book information includes a book cover and/or a book name.

In a possible implementation, in the instructions executed by the processor 801, after acquiring the first book information included in each piece of topic content, the method further includes:
based on attribute information of the first book information included in each piece of topic content, determining, from the first book information, target book information matching the search information;
the step of displaying the topic card on the search result page includes:
displaying, on the search result page, the topic card including the target book information.

In a possible implementation, in the instructions executed by the processor 801, the step of displaying the topic card on the search result page includes:
displaying the first book information and multiple topic sub-cards on the topic card;
displaying topic content on the topic sub-cards, and highlighting target content in the topic content which matches the keyword in the search information.

In a possible implementation, in the instructions executed by the processor 801, the step of displaying the first book information and the multiple topic sub-cards on the topic card includes:
displaying the multiple topic sub-cards on the topic card, and displaying, on each topic sub-card, the first book information included in the topic content that is displayed on the topic sub-card; or,
displaying the multiple topic sub-cards in a first position area of the topic card, and displaying the first book information in a second position area of the topic card.

In a possible implementation, in the instructions executed by the processor 801, the method further includes:
determining associated search information matching the search information in at least one dimension, wherein the dimension includes an author dimension, a book type dimension and a book name dimension;
displaying the associated search information on the search result page, wherein the associated search information is used for prompting a user to perform supplementary search.

In a possible implementation, in the instructions executed by the processor 801, the method further includes:
performing word segmentation processing on the search information, and when it is detected that the search information includes a preset book feature keyword, screening the first book information based on the preset book feature keyword, wherein the preset book feature keyword is used for describing feature information of a book;
the step of displaying the topic card on the search result page includes:
displaying, on the search result page, the topic card including the screened first book information.

In a possible implementation, in the instructions executed by the processor 801, the method further includes:
acquiring recommended book information;
displaying, on the search result page, a book recommendation card including the recommended book information.

In a possible implementation, in the instructions executed by the processor 801, the step of acquiring the recommended book information includes:
determining an associated keyword having an association relationship with the keyword in the search information, and acquiring recommended book information corresponding to the associated keyword; or,
acquiring recommended book information having an association relationship with the first book information; or,
searching for recommended book information matching the keyword in the search information.

In a possible implementation, in the instructions executed by the processor 801, the method further includes:
when it is detected that the search information includes a book label, acquiring second book information corresponding to the book label, and displaying the second book information on the search result page, wherein the book label is used for representing a type of a book.

In a possible implementation, in the instructions executed by the processor 801, in the case that the search information includes multiple book labels, the step of acquiring the second book information corresponding to the book label includes:
determining and acquiring second multi-associated book information simultaneously associated with the multiple book labels; and determining and acquiring second single-associated book information associated with any one of the plurality of book labels.

Embodiments of the present disclosure further provide a computer-readable storage medium, wherein a computer program is stored on the computer-readable storage medium. The computer program, when run by a processor, executes the steps of the information search method in the above method embodiments. The storage medium may be a volatile or non-volatile computer-readable storage medium.

Embodiments of the present disclosure further provide a computer program product, wherein the computer product carries a program code. Instructions included in the program code may be used for executing the steps of the information search method in the above method embodiments, reference may be specifically made to the above method embodiments, and details are not described herein again.

The computer program product may be specifically implemented by hardware, software, or a combination thereof. In an optional embodiment, the computer program product is specifically embodied as a computer storage medium, and in another optional embodiment, the computer program product is specifically embodied as a software product, such as a software development kit (SDK), etc.

It can be clearly understood by those skilled in the art to which the present disclosure belongs that, for the convenience and brevity of description, with regard to the specific operation processes of the system and apparatus described above, reference may be made to the corresponding processes in the foregoing method embodiments, and thus details are not described herein again. In the several embodiments provided by the present disclosure, it should be understood that, the disclosed apparatus and method may be implemented in other manners. The apparatus embodiments described above are merely exemplary, for example, the division of the units is only a logic function division, there may be other division manners in practical implementation, for example, multiple units or components may be combined or integrated to another system, or some features may be omitted or not implemented. From another point of view, the displayed or discussed mutual coupling or direct coupling or communication connection may be indirect coupling or communication connection of apparatuses or units through some communication interfaces, and may be in electrical, mechanical or other forms.

The units described as separate components may be separated physically or not, components displayed as units may be physical units or not, namely, may be located in one place, or may be distributed on multiple units. A part of or all of the units may be selected to implement the purposes of the solutions in the present embodiment according to actual demands.

In addition, the functional units in various embodiments of the present disclosure may be integrated in one processing unit, or each unit individually physically exist, or two or more units are integrated in one unit.

If the function is implemented in the form of a software functional unit and is sold or used as an independent product, it may be stored in a processor-executable non-volatile computer-readable storage medium. Based on this understanding, the technical solutions of the present disclosure substantially, or the part contributing to the prior art, or part of the technical solutions may be implemented in the form of a software product, the computer software product is stored in a storage medium, which includes several instructions for enabling a computer device (which may be a personnel computer, a server, or a network device or the like) to execute all or part of the steps of the method in various embodiments of the present disclosure. The foregoing storage medium includes a variety of media capable of storing program codes, such as a USB disk, a mobile hard disk, a read-only memory (ROM), a random access memory (RAM), a magnetic disk, or an optical disk.

Finally, it should be noted that the above embodiments are merely specific implementations of the present disclosure, and are used for illustrating the technical solutions of the present disclosure rather than limiting the same. The protection scope of the present disclosure is not limited thereto. Although the disclosure has been described in detail with reference to the foregoing embodiments, those ordinary skilled in the art should understand that any skilled who is familiar with this art may still modify or easily conceive of changes to the technical solutions recited in the foregoing embodiments, or equivalently replace some of the technical features therein within the technical scope disclosed in the present disclosure; and these modifications, changes or substitutions do not make the essence of the corresponding technical solutions depart from the spirit and scope of the technical solutions of embodiments of the present disclosure, and shall fall within the protection scope of the present disclosure. Therefore, the protection scope of the present disclosure shall be subject to the protection scope of the claims.

I/We claim:

1. An information search method, comprising:
receiving search information;
acquiring a plurality of pieces of topic content corresponding to a keyword in the search information and first book information comprised in each piece of topic content; and
displaying a topic card on a search result page, wherein the topic card comprises the plurality of pieces of topic content and the first book information.

2. The method according to claim 1, wherein before acquiring the plurality of pieces of topic content corresponding to the keyword in the search information and the first book information comprised in each piece of topic content, the method further comprises:
confirming an absence of a book matching the keyword in the search information;
wherein confirming the absence of the book matching the keyword in the search information comprises:
the search information comprises a book name, but there is an absence of a book corresponding to the book name in a database; or,
detecting that the search information fails to comprise a book name.

3. The method according to claim 1, wherein the first book information comprised in each piece of topic content is determined according to comment information in each piece of topic content, and the first book information comprises a book cover and/or a book name.

4. The method according to claim 1, wherein after acquiring the first book information comprised in each piece of topic content, the method further comprises:
based on attribute information of the first book information comprised in each piece of topic content, determining, from the first book information, target book information matching the search information; and
the step of displaying the topic card on the search result page comprises: displaying, on the search result page, the topic card comprising the target book information.

5. The method according to claim 1, wherein the step of displaying the topic card on the search result page comprises:
displaying the first book information and a plurality of topic sub-cards on the topic card; and
displaying topic content on the topic sub-cards, and highlighting target content in the topic content which matches the keyword in the search information.

6. The method according to claim 5, wherein the step of displaying the first book information and the plurality of topic sub-cards on the topic card comprises:
displaying the plurality of topic sub-cards on the topic card, and displaying, on each topic sub-card, the first book information comprised in the topic content that is displayed on the topic sub-card; or,
displaying the plurality of topic sub-cards in a first position area of the topic card, and displaying the first book information in a second position area of the topic card.

7. The method according to claim 1, wherein the method further comprises:
determining associated search information matching the search information in at least one dimension, wherein the dimension comprises an author dimension, a book type dimension and a book name dimension; and
displaying the associated search information on the search result page, wherein the associated search information is used for prompting a user to perform supplementary search.

8. The method according to claim 1, wherein the method further comprises:
performing word segmentation processing on the search information, and when it is detected that the search information comprises a preset book feature keyword, screening the first book information based on the preset book feature keyword, wherein the preset book feature keyword is used for describing feature information of a book; and
the step of displaying the topic card on the search result page comprises: displaying, on the search result page, the topic card comprising the screened first book information.

9. The method according to claim 1, wherein the method further comprises:
acquiring recommended book information; and
displaying, on the search result page, a book recommendation card comprising the recommended book information.

10. The method according to claim 9, wherein the step of acquiring the recommended book information comprises:
determining an associated keyword having an association relationship with the keyword in the search information, and acquiring recommended book information corresponding to the associated keyword; or,
acquiring recommended book information having an association relationship with the first book information; or,
searching for recommended book information matching the keyword in the search information.

11. The method according to claim 1, wherein the method further comprises:
when it is detected that the search information comprises a book label, acquiring second book information corresponding to the book label, and displaying the second book information on the search result page, wherein the book label is used for representing the type of the book.

12. The method according to claim 11, wherein in the case that the search information comprises a plurality of book labels, the step of acquiring the second book information corresponding to the book label comprises:
determining and acquiring second multi-associated book information simultaneously associated with the plurality of book labels; and
determining and acquiring second single-associated book information associated with any one of the plurality of book labels.

13. A computer device, comprising:
a processor;
a memory; and
a bus, wherein the memory stores a machine-readable instruction executable by the processor, when the computer device operates, the processor communicates with the memory through the bus, and the machine-readable instruction, when executed by the processor, executes the steps of:
receiving search information;
acquiring a plurality of pieces of topic content corresponding to a keyword in the search information and first book information comprised in each piece of topic content; and
displaying a topic card on a search result page, wherein the topic card comprises the plurality of pieces of topic content and the first book information.

14. The computer device of claim 13, before acquiring the plurality of pieces of topic content corresponding to the keyword in the search information and the first book information comprised in each piece of topic content, the machine-readable instruction, when executed by the processor, executes the steps of:
confirming an absence of a book matching the keyword in the search information;
wherein confirming the absence of the book matching the keyword in the search information comprises:
the search information comprises a book name, but there is an absence of a book corresponding to the book name in a database; or,
detecting that the search information fails to comprise a book name.

15. The computer device of claim 13, wherein the machine-readable instruction, when executed by the processor, executes the steps of:
based on attribute information of the first book information comprised in each piece of topic content, determining, from the first book information, target book information matching the search information; and
the step of displaying the topic card on the search result page comprises: displaying, on the search result page, the topic card comprising the target book information.

16. The computer device of claim 13, wherein the machine-readable instruction, when executed by the processor, executes the steps of:
determining associated search information matching the search information in at least one dimension, wherein the dimension comprises an author dimension, a book type dimension and a book name dimension; and
displaying the associated search information on the search result page, wherein the associated search information is used for prompting a user to perform supplementary search.

17. The computer device of claim 13, wherein the machine-readable instruction, when executed by the processor, executes the steps of:
performing word segmentation processing on the search information, and when it is detected that the search information comprises a preset book feature keyword, screening the first book information based on the preset book feature keyword, wherein the preset book feature keyword is used for describing feature information of a book; and
the step of displaying the topic card on the search result page comprises: displaying, on the search result page, the topic card comprising the screened first book information.

18. The computer device of claim 13, wherein the machine-readable instruction, when executed by the processor, executes the steps of:
when it is detected that the search information comprises a book label, acquiring second book information corresponding to the book label, and displaying the second book information on the search result page, wherein the book label is used for representing the type of the book.

19. The computer device of claim 18, wherein the machine-readable instruction, when executed by the processor, executes the steps of:
determining and acquiring second multi-associated book information simultaneously associated with the plurality of book labels; and
determining and acquiring second single-associated book information associated with any one of the plurality of book labels.

20. A non-transitory computer-readable storage medium, wherein a computer program is stored on the computer-readable storage medium, and the computer program, when run by a processor, executes the steps of:
receiving search information;
acquiring a plurality of pieces of topic content corresponding to a keyword in the search information and first book information comprised in each piece of topic content; and
displaying a topic card on a search result page, wherein the topic card comprises the plurality of pieces of topic content and the first book information.
